(19) United States
(12) Patent Application Publication
(10) Pub. No.: US 2012/0194541 A1
(43) Pub. Date: Aug. 2, 2012

(54) APPARATUS TO EDIT AUGMENTED REALITY DATA

(75) Inventors: Jin-Wook KIM, Seoul (KR); Sung-Eun KIM, Seoul (KR)

(73) Assignee: PANTECH CO., LTD., Seoul (KR)

(21) Appl. No.: 13/224,880

(22) Filed: Sep. 2, 2011

(30) Foreign Application Priority Data
Jan. 27, 2011 (KR) 10-2011-0008457

(51) Int. Cl. G09G 5/00

(52) U.S. Cl. 345/619

(57) ABSTRACT

Provided is a technique of allowing a user to store, edit, or create AR data provided from an AR service. An Augmented Reality (AR) editing apparatus includes: an image acquiring unit to acquire an image including at least one object; an object information data receiver to receive at least one piece of object information data; a storage management unit to selectively store the object information data; and an image creator to create an AR image using the image and the object information data.

### CROSS-REFERENCE TO RELATED APPLICATION

This application claims priority from and the benefit under 35 U.S.C. §119(a) of Korean Patent Application No. 10-2011-0008457, filed on Jan. 27, 2011, which is incorporated by reference for all purposes as if fully set forth herein.

### BACKGROUND

1. Field

The following description relates to an Augmented Reality (AR) editing apparatus, and more particularly, to an Augmented Reality (AR) editing apparatus to store and edit AR data to create new AR data.

2. Discussion of the Background

Recently, smart phones incorporating data communication applications, such as scheduling, fax, Internet access, etc., and the general applications of mobile phone have come into wide use. One of the key characteristics of a smart phone is that a user can install or add applications (application programs) or delete unnecessary applications from the mobile phone. This differs from traditional mobile phones which have limited applications installed therein when the mobile phones are manufactured and released.

Recently, applications using Augmented Reality (AR) are increasing. AR is a technique of synthesizing a virtual world with a real environment in real time and providing the result of the synthesis to a user. AR offers users improved immersion and reality. AR provides additional information by combining real objects or places with virtual reality.

Even though AR service providers can provide different types of information and differentiate content to be provided to individual users, users have no choice but to depend on AR data that is provided by AR service providers. In other words, a technique of providing more detailed, user-specialized information about objects has not yet been realized.

### SUMMARY

Exemplary embodiments of the present invention provide an apparatus to store, edit, and create Augmented Reality (AR) data that is provided from an AR service.

Additional features of the invention will be set forth in the description which follows, and in part will be apparent from the description, or may be learned by practice of the invention.

An exemplary embodiment of the present invention discloses an Augmented Reality (AR) editing apparatus including: an image acquiring unit to acquire an image including at least one object; an object information data receiver to receive object information data; a storage management unit to selectively store the object information data; and an image creator to create an AR image using the image and the object information data.

An exemplary embodiment of the present invention also discloses a AR editing apparatus including: a location information creator to generate location information of the AR editing apparatus; an object information map data receiver to receive map data corresponding to the location information of the AR editing apparatus, and object information map data corresponding to the map data; a storage management unit to selectively store the object information map data; and an image creator to create an AR image using the map data and the object information map data.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an Augmented Reality (AR) editing apparatus according to an exemplary embodiment.

FIG. 2 is a diagram illustrating a storage management unit according to an exemplary embodiment.

FIG. 3A is a view of AR data according to an exemplary embodiment.

FIG. 3B is a view of AR data according to an exemplary embodiment.

FIG. 4A is a view of sharing AR data according to an exemplary embodiment.

FIG. 4B is a view of different types of AR according to an exemplary embodiment.

FIG. 5 is a diagram illustrating an AR editing apparatus according to an exemplary embodiment.

FIG. 6 is a view of edited AR data according to an exemplary embodiment.

FIG. 7 is a view to illustrate the AR editing apparatus communicating with an external device according to an exemplary embodiment.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements. It will be understood that when an element or layer is referred to as being “on” or “connected to” another element, it can be directly on or directly connected to the other element, or intervening elements may be present. The description of well-known operations and constructions may be omitted for increased clarity and conciseness.

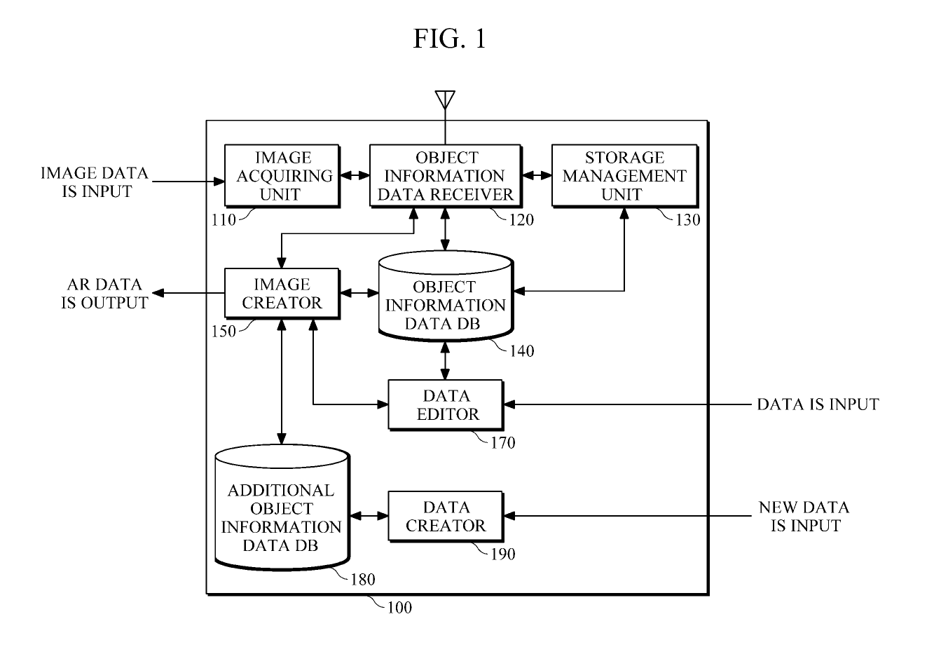

FIG. 1 is a diagram illustrating an Augmented Reality (AR) editing apparatus according to an exemplary embodiment. Referring to FIG. 1, the AR editing apparatus 100 includes an image acquiring unit 110, an object information data receiver 120, a storage management unit 130, an object information data DB 140, an image creator 150, a data editor 170, an additional object information data DB 180, and a data creator 190. The image acquiring unit 110 may include a camera or an image sensor for acquiring images including at least one object. An image acquired by the image acquiring unit 110 includes the location information, inclination information, etc., of a terminal if the image is acquired. The image acquiring unit 110 outputs the acquired image to the storage management unit 130.

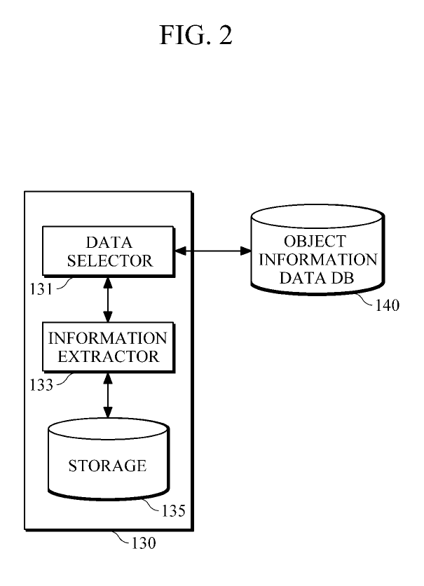

The object information data receiver 120 transmits image information received from the image acquiring unit 110 to an external server. The object information data receiver 120 receives object information data, which is AR data corresponding to the image information, from the external server. The object information data receiver 120, which may be a communication module communicating with a server, may be a Near Field Communication (NFC) module, such as Bluetooth® and Wifi®, or a far field communication module, such as LAN or a satellite communication module. The object information data receiver 120 transmits location information of an object, included in the image acquired by the image acquiring unit 110, to the server, and receives object information data from the server. The object information data receiver 120 temporarily stores the received object information data in the object information data DB 140, and outputs a data reception signal to a data selector 131 (see FIG. 2). The object information data may be classified according to AR services, and stored in the object information data DB 140.

The storage management unit 130 may be a microprocessor to perform a data processing operation of the AR editing apparatus 100. The storage management unit 130 may be a multicore processor to process various tasks at the same time. The storage management unit 130 selectively stores the received object information data in the object information data DB 140. The object information data may be stored according to individual categories of location, size, content, etc. The storage management unit 130 will be described in more detail with reference to FIG. 2, below.

FIG. 2 is a diagram illustrating a storage management unit according to an exemplary embodiment.

Referring to FIG. 2, the storage management unit 130 includes a data selector 131, an information extractor 133, and a storage 135. The data selector 131, which may be a user interface, recognizes object information data selected by a user. The object information data may be data, for example, if an image of a street including a crossroads is acquired, the data selector 131 receives object information data about objects included in the image. A user selects object information data that is to be stored, from among multiple pieces of object information data displayed on a display, and stores the selected object information data in the storage 135 through the information extractor 133.

The information extractor 133 extracts information for each category from the object information data selected by the data selector 131. The information extractor 133 parses the object information data stored in the object information data DB 140 using specific category information, and stores the parsed object information data according to each category. The information extractor 133 may extract information about a specific object from object information data provided from different servers, based on location information and inclination information of the corresponding object. For example, object information data about an object A provided from an AR service server B and object information data about the object A provided from an AR service server C may be classified into the same category and stored based on the location information, inclination information, etc., of the object A.

The storage 135 stores the object information data extracted by the information extractor 133 for each category. Since object information data is stored for each category, the user may create new AR data using information from individual categories. The storage 135 may be disposed in the storage management unit 130, or may be part of the object information data DB 140. The object information data extracted by the information extractor 133 may be stored in an external server.

Referring again to FIG. 1, the AR editing apparatus 100 can edit the stored object information data. The data editor 170 is connected to the object information data DB 140 or to the storage 130 of the storage management unit 130. The data editor 170 may edit the object information data received from the AR service server according to an input from a user. The data editor 170 may edit content information, location information, etc., of the object information data, as well as display information, such as the shape, size, color, etc., of the object information data. For example, if object information data about an object A is “café A, located in Gangnam-gu, Seoul,” the object information data for the object A is changed if information about the object A changes.

In a conventional AR service to change the object information data for the object A depends on updated information from the corresponding service server. However, the AR editing apparatus 100 can update object information data in real time by allowing a user to directly edit the object information data so that the user can edit the object information data according to a user's taste. The data editor 170 may output the edited object information data to the image creator 150.

The data creator 190 creates additional object information data corresponding to the object. The additional object information data is distinguished from the object information data, and may be created based on input information received through a user interface. The additional object information data refers to AR data that is created directly by a user. The user may create display information and substantial information through a virtual keyboard on a display, or other input device, in order to create the user's unique AR data for the object. By connecting the AR editing apparatus 100 to a computer, it is possible to create AR data directly on the computer and store the AR data in the AR editing apparatus 100.

The data creator 190 may create the additional object information data using a part of the object information data. In other words, the data creator 190 may change content, shape, etc., of the object information data, and maintain location information and inclination information included in the object information data. Accordingly, the user may easily and accurately create the additional object information data. The data creator 190 stores the additional object information data created as described above in the additional object information data DB 180.

The image creator 150 creates an AR image using the image acquired by the image acquiring unit 110 and the object information data or the additional object information data. The image creator 150 is connected to the object information data 140 and the additional object information data DB 180, and extracts data from the object information data 140 and the additional object information data DB 180. The image creator 150 may be connected to the object information data receiver 120 and/or the data editor 170. The image creator 150 may display all or a part of the object information data and the additional object information data on an AR image.

If the image creator 150 displays both the object information data and the additional object information data, the image creator 150 may differentiate at least one of the shape, size and color of the object information data and the additional object information data in order to distinguish the object information data from the additional object information data. If object information data corresponding to an object overlaps additional object information data corresponding to the object, the image creator 150 may display a single piece of AR data, and then display another piece of AR data according to a user's selection.

The image creator 150 may determine whether object information data overlaps additional object information data, and assign priority to one of the object information data and the additional object information data if the object information data overlaps the additional object information data. For example, if a user assigns priority to additional object information data created by the user, the user acquires information related to an object based on the additional object information data, if receiving an AR service for the corresponding object.

The image creator 150 may create an AR image such that object information data is displayed in a different form in comparison to the additional object information data. In order to display object information data in a different form, the object information data and the additional object information data are checked to see if they match. It is possible to differentiate the size, color, content, etc., of the object information data from those of the additional object information data.

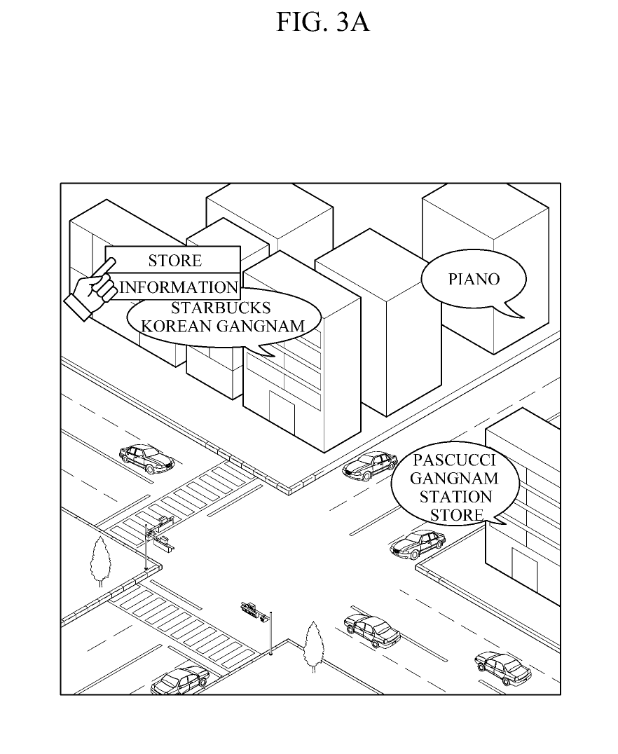

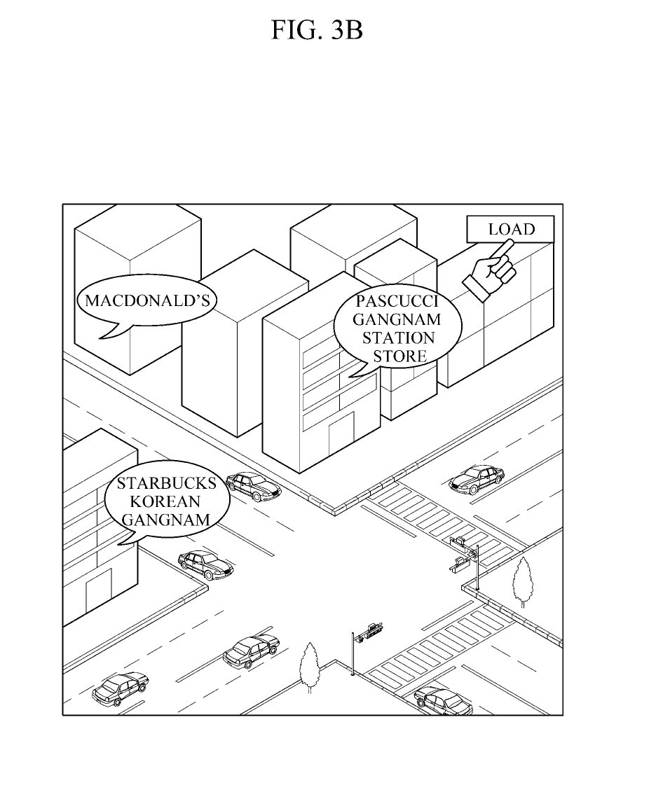

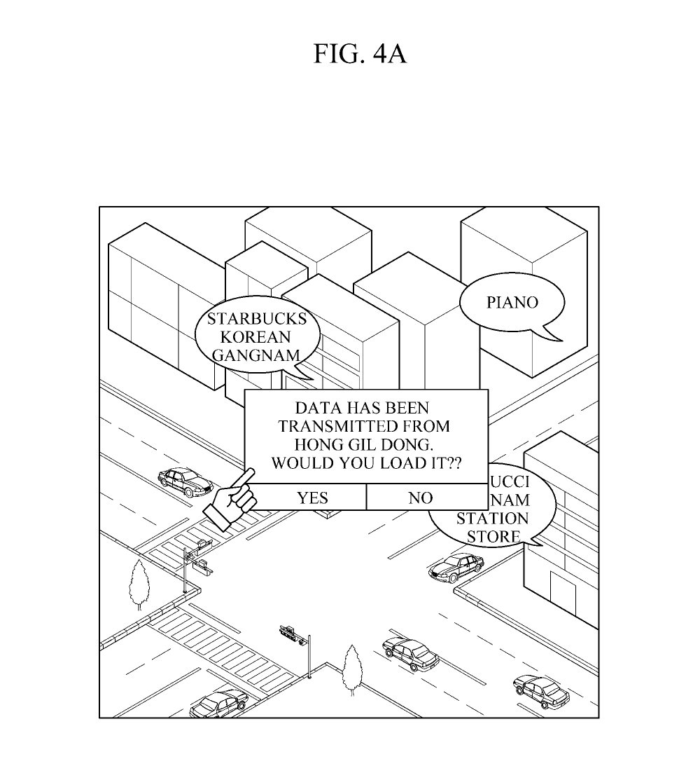

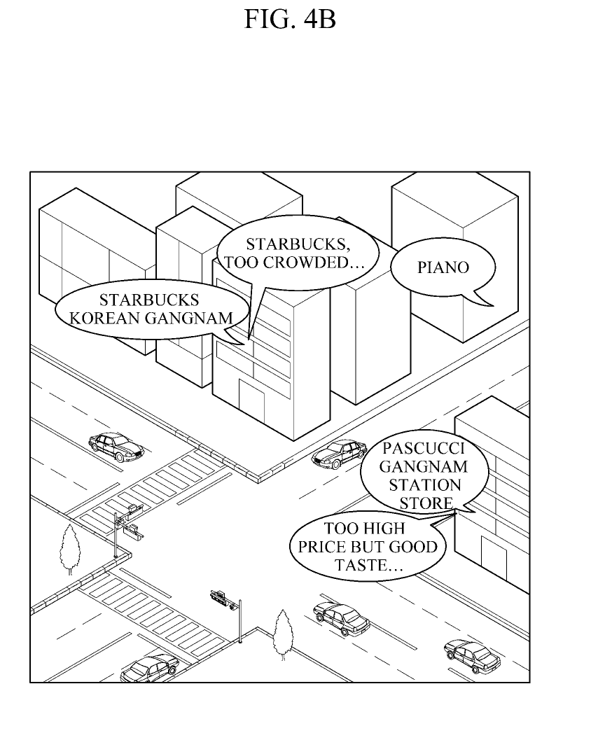

Hereinafter, an operation method of the AR editing apparatus 100 will be described in detail with reference to FIG. 3A, FIG. 3B, FIG. 4A and FIG. 4B.

FIG. 3A is a view of AR data according to an exemplary embodiment. FIG. 3B is a view of AR data according to an exemplary embodiment.

FIG. 3A shows an AR image in which object information data is arranged on an image including a plurality of objects acquired through the AR editing apparatus 100. It is assumed that a user stores object information data “Starbucks Korea Gangnam.” The user touches a location at which the user desired object information data “Starbucks Korea Gangnam” is displayed on the display and a selection window is displayed. The user selects whether to store the object information data “Starbucks Korea Gangnam” or whether to acquire details about the object information data “Starbucks Korea Gangnam.” If the user chooses to store the object information data “Starbucks Korea Gangnam,” the user may store the object information data by clicking a “store” icon on the selection window. The user may store any other object information data.

The user can select all object information data included in the AR image to store the object information data concurrently. The user may store object information data about a meeting place the user often visits. The AR editing apparatus 100 may create a notice message if the object information data selected by the user has been already stored. The AR editing apparatus 100 may provide a selection icon, such as “overwrite” or “store as copy”, if the object information data overlaps another object information data.

FIG. 3B shows an AR image obtained by photographing the same general area as the AR image of FIG. 3A from a different location, and the AR image illustrated in FIG. 3B is provided from a different AR server than the AR server which provides the AR image of FIG. 3A. The same object may be provided with object information data similar to and/or different from object information data provided by the AR image of FIG. 3A. A user may additionally select new object information data and store it.

However, the user may add omitted information from among object information data included in the AR image of FIG. 3A using a “load” operation, thereby adding another object information data to be stored. In other words, the user executes the “load” operation to add another object information data to the AR image. A method of executing the “load” operation may be to click a desired object or to use a “load” icon.

The “load” operation may add additional object information data as well as object information data. Accordingly, the user may use the object information data of the AR service and object information data provided by different AR service providers if receiving the AR services in the same place. In addition, since the user can utilize additional object information data created by the user, the user can utilize an AR service according to the user's taste.

FIG. 4A is a view of sharing AR data according to an exemplary embodiment. FIG. 4B is a view of different types of AR data according to an exemplary embodiment.

Referring to FIG. 4A, an operation of receiving object information data on an AR image from an AR editing apparatus of another user will be described below. An AR editing apparatus stores a plurality of pieces of object information data in its internal DB, and AR editing apparatuses can share data. It is assumed that a user receives an AR image with a notice message indicating that object information data has been received from another user. The user can execute a “load” operation to use object information data included in an AR editing apparatus of the other user.

FIG. 4B shows the case in which object information data received from another AR editing apparatus is added to a current AR image. The object information data received from the other AR editing apparatus may include AR data created by a user of the other AR editing apparatus or AR data provided from another service provider. The AR editing apparatus may add a social network operation. For example, if existing AR data for an object “A” is “café A, located in Gangnam, Seoul,” an AR editing apparatus may receive a message, such as “café A, too crowded” or “café A, high price but good taste,” from people that have visited the café A.

If too many pieces of AR data are displayed on an AR image, a user may selectively delete or hide some of the displayed AR data. Accordingly, the user may use an AR service efficiently since the user can add desired data or delete unnecessary data in real time.

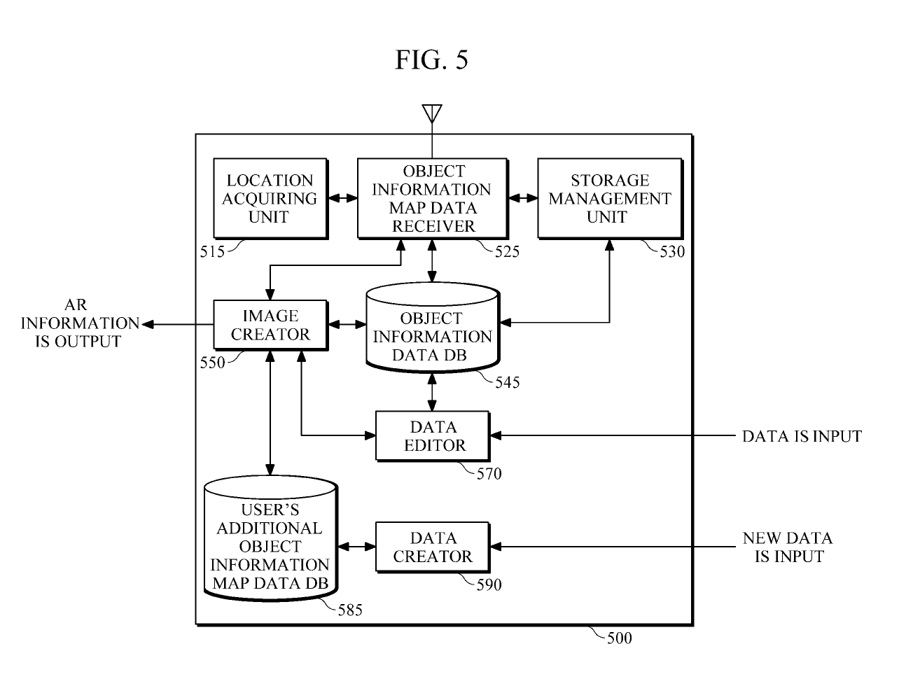

FIG. 5 is a diagram illustrating an AR editing apparatus according to an exemplary embodiment.

Referring to FIG. 5, the AR editing apparatus 500 includes a location acquiring unit 515, an object information map data receiver 525, a storage management unit 530, an object information map data DB 545, an image creator 550, a data editor 570, an additional object information map DB 585, and a data creator 590. The location acquiring unit 515 recognizes the location of the AR editing apparatus 500, and outputs the location information of the AR editing apparatus 500 to the storage management unit 530. The location acquiring unit 515 may include a GPS module. The location acquiring unit 515 generates coordinate information regarding the location of the AR editing apparatus 500 based on information received through a satellite.

The object information map data receiver 525 transmits the coordinate information acquired by the location acquiring unit 515 to a server. The object information map data receiver 525 receives object information map data from the server. The object information map data refers to AR map data corresponding to the coordinate information. The object information map data receiver 525, which is a communication module communicating with the server, may be a Near Field Communication (NFC) module, such as Bluetooth® and Wifi®, or a far field communication module, such as LAN or a satellite communication module.

The object information map data receiver 525 transmits location information of an object included in the coordinate information acquired by the location acquiring unit 515 to the server, and receives object information map data from the server. The object information map data receiver 525 temporarily stores the received object information map data in the object information map data DB 545, and outputs a data reception signal to the storage management unit 530. The object information map data may be classified according to individual AR services and stored in the object information map data DB 545.

The storage management unit 530 recognizes the current location information of the AR editing apparatus acquired by the location acquiring unit 515. The location acquiring unit 515 receives from an AR server map data, which refers to map information corresponding to the location information of the AR editing apparatus, and object information map data, which refers to AR information of the map data. The object information map data may be transmitted after being mapped to the map data, or may be transmitted separately as it is. The AR server provides a map service. The storage management unit 530 selectively stores the received object information map data. The storage management unit 530 extracts information for each category from the object information map data and stores the extracted information in the object information map data DB 545.

If object information map data of another map service is stored in the AR editing apparatus, the storage management unit 530 may add the object information map data on a current AR image using a “load” operation. The storage management unit 530 may store object information map data received from another AR editing apparatus, and add the object information map data on an AR image.

The image creator 550 creates an AR image using the map data and the object information map data. In detail, the image creator 550 may create an AR image by mapping the map data to the object information map data. The image creator 550 may map additional object information map data stored in the additional object information map data DB 585 to the map data. The additional object information map data refers to AR map data created directly by the user.

The data editor 570 edits the received object information map data according to data that has been input by the user. The data creator 590 may store the additional object information map data, which refers to AR map data created directly by the user, and include the additional object information map data in the AR image. The operations of the storage management unit 530, the image creator 550, the data editor 570, and the data creator 590 of the AR editing apparatus 500 are the same as or similar to the operations of the storage management unit 130, the image creator 150, the data editor 570, and the data creator 190, respectively, described with reference to FIG. 1 and FIG. 2.

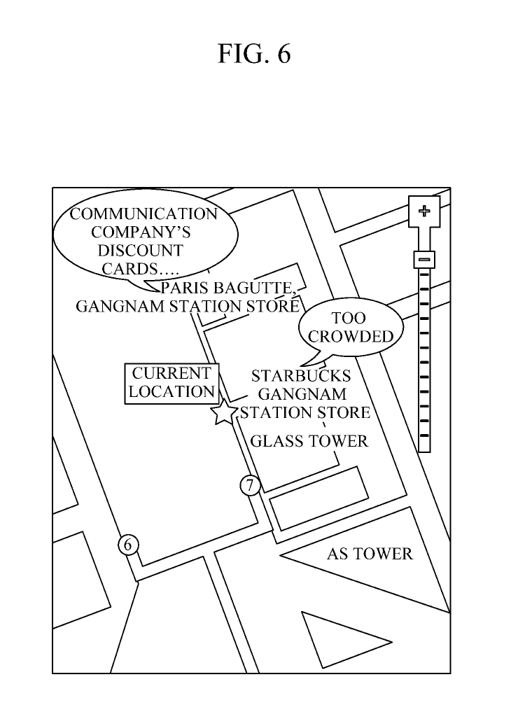

FIG. 6 is a view of edited AR data according to an exemplary embodiment. Referring to FIG. 6, map data corresponding to an area around a subway station, and object information map data about objects included in the map data are displayed. Simple tag information is displayed on each object. By clicking each object information map data, the object information map data may be stored and additional information for the object information map data may be checked. Each object information map data may be deleted or edited. In addition, additional object information map data created by a user may be displayed together with object information map data.

If object information map data is received and stored from another user, a user may display the object information map data on an AR image. Various kinds of additional information, such as comments or reviews from other users, about each object may be displayed on the AR image. Accordingly, if the user executes an AR operation related to the subway station, the user can easily use various kinds of information based on additional information set by the user.

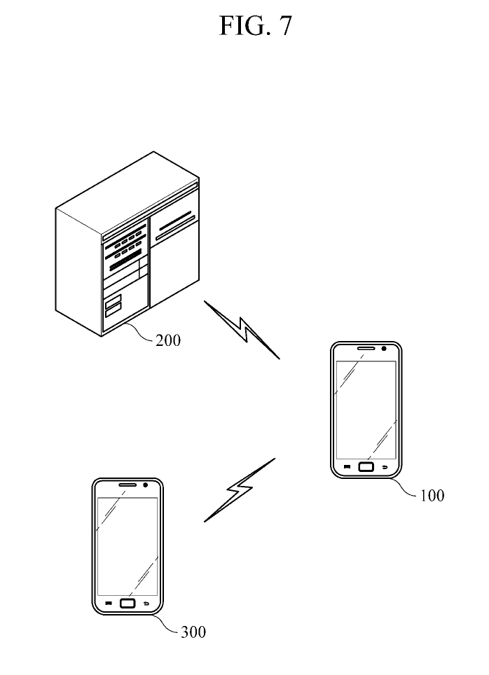

FIG. 7 is a view to illustrate the AR editing apparatus communicating with an external device according to an exemplary embodiment.

Referring to FIG. 7, the AR editing apparatus 100 may communicate with an AR service server 200 and/or another AR editing apparatus 300. The AR editing apparatus 100 may be installed in a mobile phone, a tablet PC, game console, or the like, which can execute applications. The AR editing apparatus 100 may communicate with a server through a wired/wireless network. The AR editing apparatus 100 may download applications that perform an AR execution operation from the AR service server 200, etc. The AR service server 200 receives location information, etc., from an AR integrated information providing apparatus, extracts an AR service corresponding to the received location information, and transmits the AR service. The AR service server 200 may include one or more servers corresponding to the AR services that are provided. The AR service server 200 may transmits AR data to the AR editing apparatus 100 through a wired/wireless network connection or the Internet.

The AR editing apparatus 100 may share AR data with the other AR editing apparatus 300. The AR editing apparatus 100 may communicate with other AR editing apparatuses located near or far from the AR editing apparatus 100, through a Wifi® module, a Bluetooth® module, a 3G data communication module, etc. Accordingly, a social network application, etc., may be implemented through AR data between users.

By allowing users to store or edit AR data provided by an AR service or to directly create AR data, the user will be able to use various AR data interactively. In addition, by sharing AR data with many users, users will be able to use more-specialized AR services.

The above-described examples may be implemented as a computer-readable code in a non-transitory computer-readable recording medium. The non-transitory computer-readable recording medium includes all the types of recording devices storing the data readable by a computer system. An example of the non-transitory computer-readable recording medium includes a ROM, a RAM, a CD-ROM, a magnetic tape, a floppy disk, an optical data storage unit, or the like. In addition, the non-transitory computer-readable recording medium is distributed into the computer system connected to the network and may be stored and executed with the computer-readable code in the distribution manner. The functional program, code, and code segments to implement the present invention may be easily inferred by a person skilled in the art to which the present invention belongs.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An Augmented Reality (AR) editing apparatus, the apparatus comprising:
an image acquiring unit to acquire an image including at least one object;
an object information data receiver to receive object information data;
a storage management unit to selectively store the object information data; and
an image creator to create an AR image using the image and the object information data.

2. The AR editing apparatus of claim 1, wherein the object information data is received from an AR server and/or from another AR editing apparatus.

3. An AR editing apparatus of claim 1, wherein the storage management unit comprises:
a data selector to select object information data that is to be stored from the object information data;
an information extractor to extract object information data according to a specific category from the object information data selected by the data selector; and
a storage to store the extracted object information data according to the specific category.

4. The AR editing apparatus of claim 3, wherein the data selector selects the object information data to be stored while AR data is displayed on a display.

5. The AR editing apparatus of claim 1, further comprising a data editor to edit the object information data received by the object information data receiver to correspond to input data received by the data editor.

6. The AR editing apparatus of claim 1, further comprising a data creator to create additional object information data created based on input information from a user and/or the object information data about the object.

7. The AR editing apparatus of claim 6, wherein the image creator creates the AR image using the object information data and the additional object information data.

8. The AR editing apparatus of claim 6, wherein the image creator determines whether the object information data overlaps with the additional object information data, and assigns priority to one of the object information data and the additional object information data if the object information data overlaps with the additional object information data.

9. The AR editing apparatus of claim 6, wherein the image creator creates the AR image such that the object information data and the additional object information data are displayed in different forms.

10. An AR editing apparatus, comprising:
a location information creator to generate location information of the AR editing apparatus;
an object information map data receiver to receive map data corresponding to the location information of the AR editing apparatus, and object information map data corresponding to the map data;
a storage management unit to selectively store the object information map data; and
an image creator to create an AR image using the map data and the object information map data.

11. The AR editing apparatus of claim 10, wherein the storage management unit receives the object information map data from an AR server and/or from another AR editing apparatus.

12. The AR editing apparatus of claim 10, further comprising a data creator to create additional object information data based on input information from a user, wherein the additional object information data is AR data related to the map data.

13. The AR editing apparatus of claim 10, further comprising a data editor to edit the received object information map data to correspond to input data received by the data editor.

14. The AR editing apparatus of claim 11, wherein the image creator creates the AR image by arranging object information map data received from an AR server on map data received from another AR server.

15. The AR editing apparatus of claim 12, wherein the image creator creates the AR image by arranging at least one of the object information map data and the additional object information map data on the map data.

16. The AR editing apparatus of claim 12, displaying an AR image created by arranging the object information map data on the map data, and additionally arranging the additional object information map data on the AR image according to a user's selection.

17. A method of editing AR data, the method comprising:
acquiring an image having an object;
displaying object information data corresponding to the object;
receiving input information;
creating additional object information data according to the input information and/or the object information data;
creating edited object information data and/or edited additional object information data in response to a received input; and
displaying the edited object information data and/or the edited object information data.
